(19) United States
(12) Patent Application Publication
(10) Pub. No.: US 2002/0181700 A1
(43) Pub. Date: Dec. 5, 2002

(54) Information terminal device using automatically switchable power supply

(76) Inventor: Kensuke Unno, Kanagawa (JP)

Correspondence Address: Jay H Maioli, Cooper & Dunham, 1185 Avenue of the Americas, New York, NY, 10036, US

(21) Appl. No.: 10/048,763

(22) PCT Filed: Jul. 13, 2001
(86) PCT No.: PCT/JP01/04414

(30) Foreign Application Priority Data
May 25, 2000 (JP) 2000-155028

(51) Int. Cl. H04M 1/00; H04M 9/00

(52) U.S. Cl. 379/413; 379/387.01

(57) ABSTRACT

To provide an information terminal device capable of automatically switching a plurality of power source applying paths depending on circumstances.

Since a telephone device that performs transmission and receipt of information through a telephone circuit comprises a secondary battery for applying a power source voltage to the telephone circuit, a charger for charging a voltage stored at the secondary battery and a connector capable of being connected with an interface cable having a power source supplying line for applying the power source voltage to the telephone circuit, it is possible to reduce the exhaustion of the secondary battery to the minimum by receiving the supply of the power source from the power source supplying cable through the charger or an interface cable.

### TECHNICAL FIELD

The present invention relates to information terminal devices capable of transmitting and receiving information such as, for example, a telephone device, a print device, a camera device and the like.

### BACKGROUND ART

Conventionally, as means for carrying out data communication by accessing an outside network from a personal computer (hereinafter, referred to as a personal computer), there have been many cases in which a fixed-line home telephone and a wireless device such as, portable phone, or PHS (personal handy phone) and the like are connected to the personal computer. The standards for its connections interface are generally based on an RS-232C system or a PCMCIA (Personal Communication Memory Card International Association) system.

In this case, since a power source voltage can not be applied to the telephone from the personal computer due to the constraints of the standards, the telephone side has to receive the application of the power source voltage from an internally stored battery or charger.

Besides, in the bulletin of Japanese laid-open patent publication No. 5-153036 is disclosed a wireless telephone device which, when a portable phone is fit to a cordless telephone device, automatically switches over to a cordless mode by superimposing a switch signal on a battery charging current. publication No.9-162960 is disclosed a charger for charging the battery of a portable telephone while data are being transmitted.

However, when a power source is supplied to the conventional telephone mentioned above, time for communication hinges upon battery duration when a power source voltage is applied from an internally stored battery. Therefore, there have been inconveniences such that when a battery runs out while communication are carried out, they are once suspended, and then resumed again after the battery has been recharged.

Further, when a power source voltage is applied from a charger, since a telephone is connected to a power receiving pad for the charger, there have been inconveniences that it can not be used for mobile communication or has been troublesome when used at a place away from home or something.

Furthermore, the wireless telephone device disclosed in the bulletin of Japanese laid-open patent 5-153036 is one which mention is made of to the effect that it simply superimposes a signal on a charging current, detects the superimposed signal and switches the cellular mode to the cordless mode and vice versa but can not switch over to application of a power source voltage from an interface, which is inconvenient.

Additionally, the charger disclosed in the bulletin of Japanese laid-open patent 9-162960 is one which mention is made of to the effect that it simply functions as a charging means for a battery of a portable telephone but can not switch over to application of a power source voltage from an interface, which is inconvenient.

Therefore, the present invention is implemented in view of such a point and its object is to provide an information terminal device that can automatically switch a plurality of power source applying paths depending upon circumstances.

### DISCLOSURE OF THE INVENTION

An information terminal device of the present invention is one that performs transmission and receipt of information through a communication means.

An information terminal device of the present invention comprises, specifically, an internally stored power source unit that applies a power source voltage to a communication means, a charging means for charging a voltage stored at the internally stored power source unit and a connection unit to which an interface cable having a power source supplying line for applying a power source voltage to the communication means can be connected.

Therefore, the present invention operates as follows.

First of all, a power source supplying pattern when an information terminal device is individually used will be explained.

A supervisory means transmits to a switch means through a control line that there is no application of a voltage from the outside, and based on this notification, the switch means switches over to a power source supplying path from an internally stored power source unit, for the purpose of applying a power source voltage to a communication means from an internally stored power source unit, to apply the power source voltage to the communication means.

Next, a power source supplying pattern when an information terminal device is connected through an interface cable having a power source line will be explained.

A supervisory means detects a power source voltage supplied from a power source supplying line through an interface cable and information on the power source voltage is transmitted to a switch means through a control line. In addition, since the information terminal device does not receive the supply of the power source voltage from the charging means, the supervisory means supervises a power source voltage level of the power source supplying path and information on the power source voltage is transmitted to a switch means through a control line.

Based on the information about the power source voltage from the supervisory means, the switch means preferentially switches the power source supplying paths to the communication means from the side of a power source supplying path from an internally stored power source unit to the side of the power source supplying path from the interface cable and supplies the power sorce voltage to the communication means.

Next, a power source supplying pattern when an information terminal device is connected through an interface cable having a power source line and further, a charging means is connected thereto will be explained.

A supervisory means detects, through a power source supplying path, a power source voltage applied from a power source supplying line through an interface cable, and information on the power source voltage is transmitted to the switch means through a control means. In addition, supervisory means detects, through the power source supplying path, a power source voltage applied from a charging means, and information on the power source voltage is transmitted to the switch means through the control line.

### BRIEF DESCRIPTION OF DRAWINGS

FIG. 1 is a block diagram showing a power source supplying pattern when a telephone device is individually used.

FIG. 2 is a block diagram showing a power source supplying pattern when a telephone device is connected to a computer through an interface cable.

FIG. 3 is a block diagram showing a power source supplying pattern when a telephone device is connected to a computer through an interface cable and further, a charger is connected thereto.

FIG. 4 is a flowchart showing switch operations of a power source supplying pattern

FIG. 5 is a flowchart showing switch operations of another power source supplying pattern.

FIG. 6 is a block diagram showing how power source supplying paths and charge paths are switched.

FIG. 7 is a flowchart showing switch operations of the power source supplying paths and the charge paths

### BEST MODE FOR CARRYING OUT THE INVENTION

An information terminal device according to the embodiment of the present invention supervises a power source voltage applied from a battery or a charger for charging the battery and a power source voltage applied from an outside personal computer through an interface cable, respectively and switches receipts of the power source voltages based on the results of the supervision.

An information terminal device according to the embodiment of the present invention is applied to an information terminal device capable of transmitting and receiving information such as, for example, a telephone device, a print device, a camera device and the like.

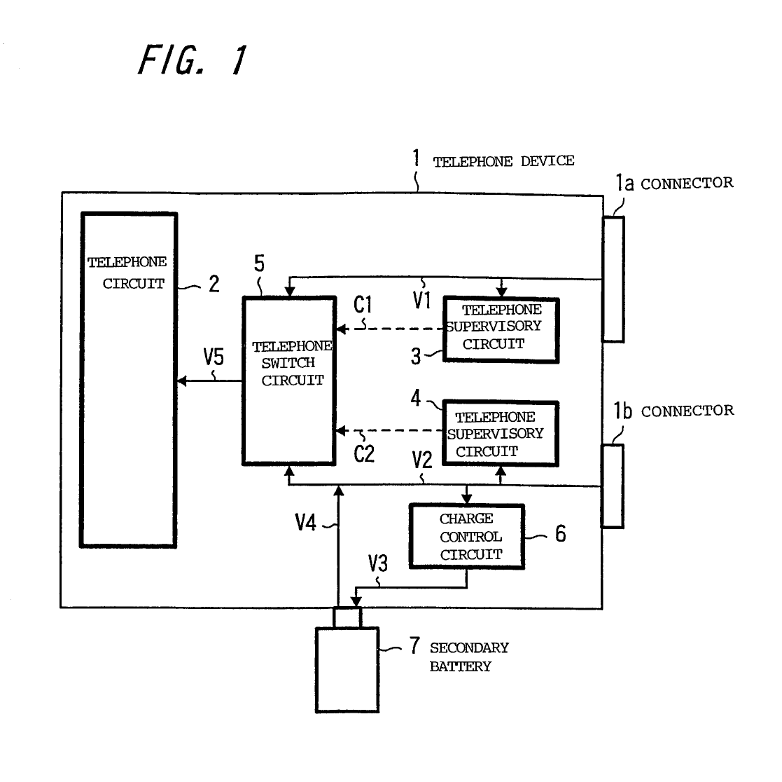

According to an information terminal device of the embodiment of the present invention, three kinds of patterns of applying a power source voltage to a telephone device as illustrated in FIGS. 1, 2, 3 are conceivable. Hereinafter, detailed explanations will be given.

FIG. 1 is a block diagram showing a power source supplying pattern when a telephone device 1 is individually used. In addition, the telephone device 1 comprises a telephone circuit 2 capable of performing transmission and receipt of information through a predetermined circuit. The circuit may be, for example. an ISDN (Integrated Services Digital Network) or a PSTN (Public Switched Telephone Network).

In FIG. 1, the telephone device 1 comprises a connector 1a capable of receiving an application of a power source voltage from a computer such as outside personal computer or the like which is not shown and a connector 1b capable of receiving an application of a power source voltage from an outside charger which is not shown.

Further, the telephone device 1 comprises a power source supervisory circuit 3 for supervising a power source voltage level (here, 0V (volt) since there is no application of the power source voltage) of a power source supplying path V1 at a time of receiving an application of the power source voltage from a computer through the interface cable and connector 1a and a power source supervisory circuit 4 for supervising a power source voltage level (here, 0V (volt) since there is no application of the power source voltage) of a power source supplying path V2 at a time of receiving an application of a power source voltage from a charger.

Furthermore, the telephone device 1 comprises a secondary battery 7 that applies a power source voltage through a power source supplying path V4 and is capable of charging as well through a power source supplying path V3 and a charge control circuit 6 for controlling a power current to charge the secondary battery 7 through the power source supplying path V3.

Finally, the telephone device 1 comprises a power source switch circuit 5 that, based on the power source voltage level (0V) of the power source supplying path V1 as supplied from the power source supervisory circuit 3 through a control line C1 and the power source voltage level (0V) of the power source supplying path V2 as supplied from the power source supervisory circuit 4 through a control line C2, switches over to the power source voltage applied from the secondary battery 7 through the power source supplying path V4 and applies the power source voltage supplied from the secondary battery 7 through the power source path V4 to a telephone circuit 2 through the power source supplying path V5.

The telephone device 1 configured as such operates as follows.

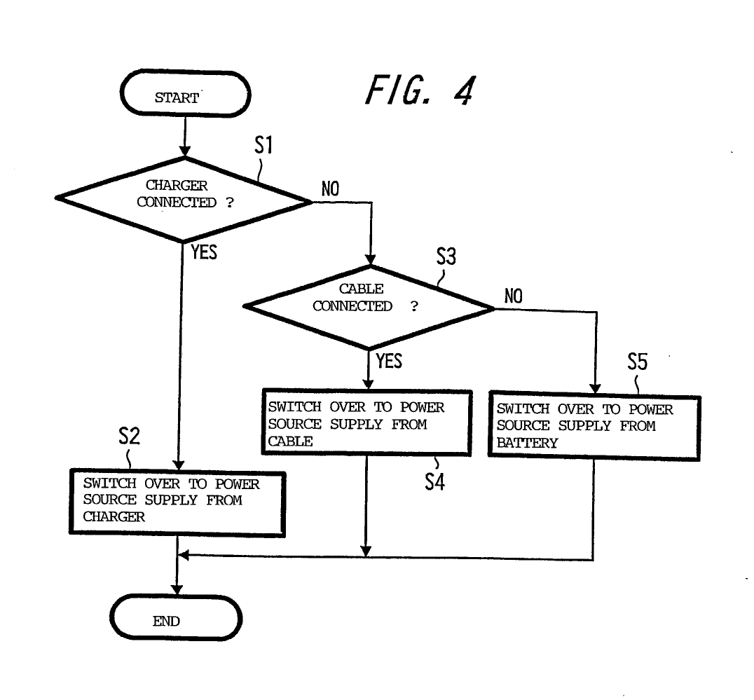

A flowchart for switch operations of a power source supplying pattern will be shown in FIG. 4.

Since an outside computer or a charger is not connected to the connector 1a and connector 1b in FIG. 1, when it comes to judging whether or not a charger is connected at step S1, control branches to NO and proceeds to step S3. When it comes to judging whether or not a cable is connected at step S3, control branches to NO and proceeds to step S5.

Two of the power source supervisory circuits 3, 4 transmits to the power source switch circuit 5 through the control lines C 1, 2 that there is no application of a power source voltage from outside and based on this notification, the power source switch circuit 5 as shown at step S5 in FIG. 4 switches over to the power source supplying path V4 from the secondary battery 7, for the purpose of applying the power source voltage to the telephone circuit 2 from the secondary battery 7, and applies the power source voltage to the telephone circuit 2 through the power source supplying path V5.

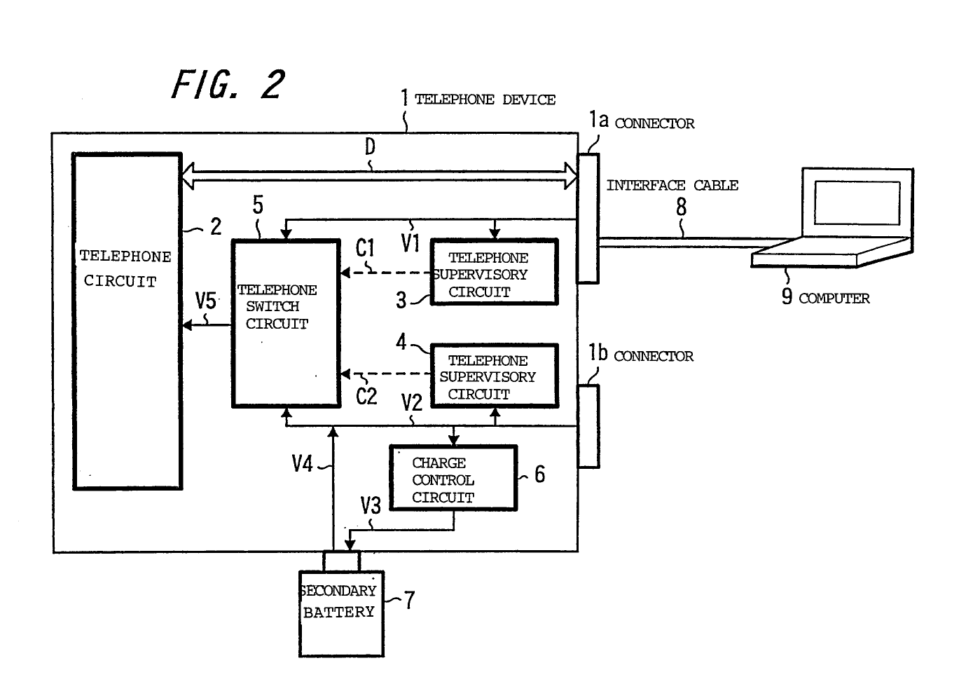

FIG. 2 is a block diagram showing a power source supplying pattern when the telephone device 1 is connected to a computer 9 through an interface cable 8. Here, the parts corresponding to those shown in FIG. 1 are attached with the same signs and explanations thereof will be omitted.

FIG. 2 differs from FIG. 1 in that it is configured such that a computer 9 is connected to the connector 1a through the interface cable 8, data D is transmitted and received between the computer 9 and the telephone circuit 2, and the computer 9 applies a power source voltage to the telephone circuit 2 through the interface cable 8 having a power source supplying line.

Here, the interface cable 8 having a power source supplying line conforms to, for example, the USB (Universal Serial Bus) format or the IEEE1394 format as an interface standard having the power source supplying line. In addition, a flowchart for switching operations of the power source supplying pattern will be shown in FIG. 4.

The telephone device 1 configured as such operates as follows.

In FIG. 2, since an outside charger is not connected to the connector 1b, when it comes to judging whether or not the charger is connected at step S1 in FIG. 4, control branches to NO and proceeds to step S3. Since the outside computer 9 is connected to the connector 1a, when it comes to judging whether or not the cable 8 is connected at step S3, control branches to YES and proceeds to step S4.

In this case, the power source supervisory circuit 3 detects a power source voltage (for example, 5V) applied from the computer 9 through the interface cable 8 and information on the power source voltage is transmitted to the power source switch circuit 5 through the control line C1.

In addition, since the telephone device does not receive an application of the power source voltage from the charger, the power source supervisory circuit 4 supervised the power source voltage level (0V) of the power souece voltage supplying path V2 and information on the power source voltage is transmitted to the power source switch circuit 5 through the control line C2.

The power source switch circuit 5, based on the information about the power source voltage from the power source supervisory circuit 3, preferentially switches the power source supplying paths to the telephone circuit 2 from the side of the power source supplying path V4 to the side of the power source supplying path V1 as shown at step S4 in FIG. 4 to thereby apply the power source voltage to the telephone circuit 2 through the power source supplying path 5.

Consequently, it becomes possible to avoid the exhaustion of the power source voltage stored at the secondary battery 7 when the computer 9 is in a state of being connected to the telephone device 1 through the interface cable 8 and the connector 1a.

Here, the power source supervisory circuit 3 determines if a voltage value (for example, 5V) capable of being used at the telephone device 1 is reached through the interface cable 8 and the connector 1a or if a voltage value (for example, 5V) capable of being used at the telephone device 1 is not reached.

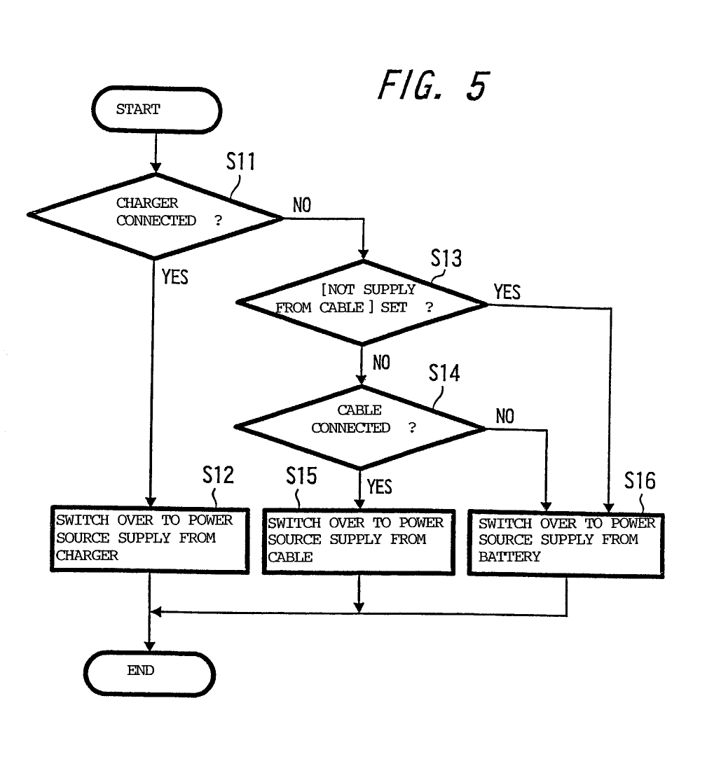

In the meantime, FIG. 5 is a flowchart showing switch operations of another power source supplying pattern.

In FIG. 2, since an outside charger is not connected to the connector 1b, when it comes to judging whether or not a charger is connected at step S11 in FIG. 5, control branches to NO and proceeds to step S13.

As will be described later on, in case a power source is not supplied from an interface cable, when it comes to judging whether or not the power source is set not to be supplied from the cable at step S13, control branches to YES and proceeds to step S16.

For example, when a power source voltage can not be supplied to the telephone device 1 because the interface cable is in a state of being disconnected from the connector 1a, or when a power source voltage is not abundantly supplied to the telephone device 1 as the computer 9 is being driven by an internally stored battery, or when a power source voltage is not abundantly supplied to the telephone device 1 as the ability of supplying the power source on the side of the computer 9 deteriorates due to the exhaustion of an internally stored battery although a charger is being used, the power source supervisory circuit 3 transmits information on the power source voltage to the power source switch circuit 5 through the control line C1.

In this case, the power source switch circuit 5, based on the information on the power source voltage, exceptionally switches over to the side of the power source supplying path V4 from the secondary battery 7 as shown at step S16 in FIG. 5 to thereby apply the power source voltage to the telephone circuit 2.

In this way, even when the computer 9 connected to the telephone device 1 through the interface cable 8 is being driven by the internally stored battery, if the exhaustion of its internally stored battery is desired to be avoided, the power source switch circuit 5 can apply the power source voltage to the telephone circuit 2 through the power source supplying path 5 by exceptionally switching over to the side of the power source supplying path V4 from the secondary battery. Additionally, the power source switch circuit 5 can perform the above-mentioned exceptional switch as set by the telephone circuit 2.

Meanwhile, judgement at steps S11, S13, S14 to processing at step S16 as shown in FIG. 5 shows the switch operations of the power source supplying path in FIG. 1 similarly to judgement at steps S1, S3 to processing at step S4 shown in FIG. 4, and judgement at steps S11, S13, S14 to processing at step S15 shown in FIG. 5 shows switch operations of the power source supplying path in FIG. 2 similarly to judgement at steps S1, S3 to processing at step S4 shown in FIG. 4.

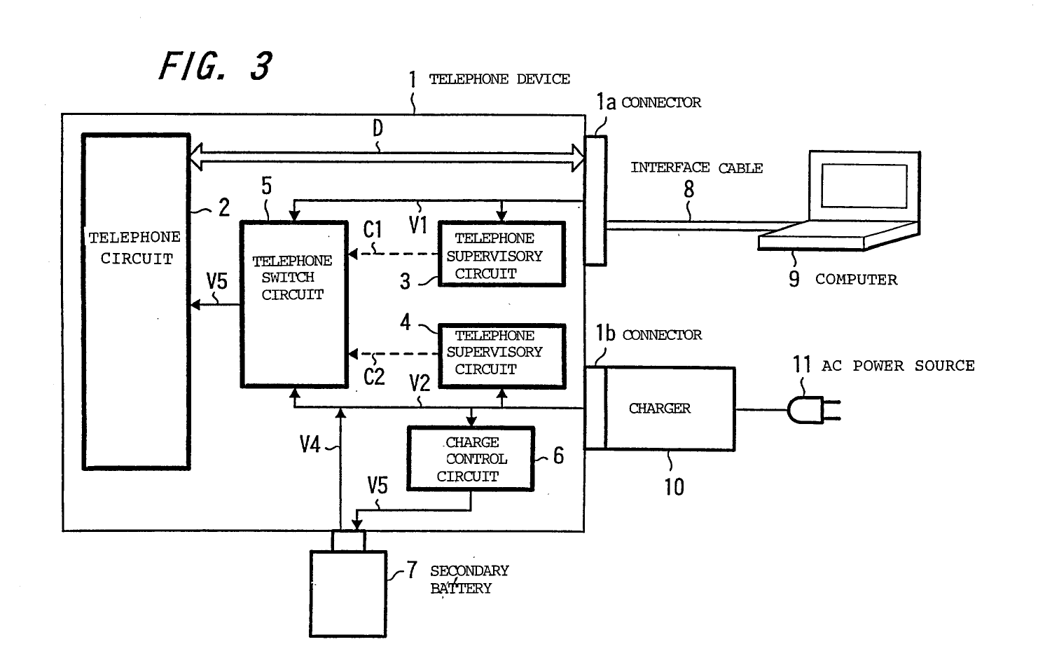

FIG. 3 is a block diagram showing a power source supplying pattern when the telephone device 1 is connected to the computer 9 through the interface cable 8 and further, a charger is connected thereto. Here, the parts corresponding to those in FIG. 1 are attached with the same signs and explanations thereof will be omitted.

FIG. 3 differs from FIG. 1 in that the former is configured such that the computer 9 is connected to the connector 1a through the interface cable 8, data D is transmitted and received between the computer 9 and the telephone circuit 2 and at the same time, a power source voltage is applied to the telephone circuit 2 from the computer 9 through the interface cable having the power source supplying line and further, a charger 10 capable of generating and applying a predetermined DC (direct current) power source (for example, 5V) from a commercial AC (alternating current) power source 11 is connected to the connector 1b so that, between the charger 10 and the telephone circuit 2, a power source voltage is applied to the telephone circuit 2 through the connector 1b.

The telephone device 1 such configured operates as follows. In addition, a flowchart for operations of the power source supplying pattern will be shown in FIG. 4.

In FIG. 3, since an outside charger is connected to the connector 1b, when it comes to judging whether or not the charger at step S1 is connected in FIG. 4, control branches to YES and proceeds to step S2.

In this case, the power source supervisory circuit 3 detects, through the power source supplying path V1, a power source voltage (for example, 5V) applied from the computer 9 through the interface cable 8 and information on the power source voltage is transmitted to the power source switch circuit 5 through the control line Cl. In addition, the power source supervisory circuit 4 detects, through the power source supplying path V2, a power source voltage (for example, 5V) applied from the charger 10 and information on the power source voltage is transmitted to the power source switch circuit 5 through the control line C2.

The power source switch circuit 5, based on the information about the power source voltage from the power source supervisory circuit 3 switches the power source supplying paths to the telephone circuit 2 from the power source supplying path V4 from the secondary battery 7 to the side of the power source supplying path V2 from the charger 10 rather than to the side of the power source supplying path V1 from the interface cable 8 as shown at step S2 in FIG. 4 to thereby apply the power source voltage to the telephone circuit 2 through the power source supplying path V5.

Consequently, it becomes possible to avoid the exhaustion of the power source voltage stored at the second battery 7 when the computer 9 is connected to the telephone device 1 through the interface cable 8 and the connector 1a as well and further, the charger 10 is connected thereto.

In addition, at this time, the secondary battery may be charged from the charger 10 simultaneously through a charge control circuit 6 and the power source supplying path V3.

Here, the power source supervisory circuit 3 confirms if a voltage value (for example, 5V) capable of being used at the telephone device 1 is reached through the interface cable 8 to the connector 1a to the power source supplying path V1. In addition, the power source supervisory circuit 4 confirms if a voltage value (for example, 5V) capable of being used at the telephone device 1 is reached through the charger 10 to the connector 1b to the power source supplying path V2.

Meanwhile, FIG. 5 is a flowchart showing switch operations of another power source supplying pattern.

In FIG. 3, since an outside charger 10 is connected to the connector 1b, when it comes to judging whether or not the charger 10 is connected at step S11 in FIG. 5, control branches to YES and proceeds to step S12. Meanwhile, judgement at step S11 to processing at step S12 as shown in FIG. 5 show switch operations of the power source supplying paths in FIG. 3 similarly to judgement at step S1 to processing at step S2 shown in FIG. 4.

Here, when the state shown in FIG. 3 changes to a state in which the charger 10 is disconnected from the connector 1b so that a power source can not be supplied to the telephone device 1, or an abundant power source can not be supplied to the telephone device 1 from the charger 10 because the supplying of an AC power source 11 is not secured, the power source supervisory circuit 4 transmits information on the power source voltage to the power source switch circuit 5 through the control line C2.

In this case, since an outside charger 10 is not connected to the connector 1b, when it comes to judging whether or not the charger is connected at step S11 in FIG. 5, control branches to NO and proceeds to step S13. When it comes to judging whether or not a power source is set not to be supplied from the cable at step S13, control branches to NO and proceeds to step S14. When it comes to judging whether or not the cable is connected at step S14, control branches to YES and proceeds to step S15.

In addition, the power source supervisory circuit 3 detects if a voltage value (for example, 5V) capable of being used at the telephone device 1 is reached through the interface cable 8 to the connector 1a to the power source supplying path V1 and tansmits information on the power source voltage to the power source switch circuit 5 through the control line C1.

Based on the information on the power source voltage, the power source switch circuit 5, as shown at step S15 in FIG. 5, exceptionally switches over to the side of the power source supplying path V1 from the interface cable 8 to thereby apply the power source voltage to the telephone circuit 2 through the power source supplying path V5.

Additionally, when this state evolves further to, for example, a state in which the interface cable 8 is disconnected from the connector 1a so that the power source voltage can not be applied to the telephone device 1, or when an abundant supply of the power source voltage can not be secured as the computer 9 is being driven by an internally stored battery, or when an abundant supplying of the power source voltage can not be secured because the power source supplying ability on the side of the computer 9 deteriorates due to the exhaustion of an internally stored battery even though the charger is being used, the power source supervisory circuit 3 transmits information on the power source voltage to the power source switch circuit 5 through the control line C1.

In this case, since an outside charger 10 is not connected to the connector 1b, when it comes to judging whether or not the charger 10 is connected at step S11 in FIG. 5, control branches to NO and proceeds to step S13.

As mentioned above, in case a power source can not be supplied from the interface cable 8, when it comes to judging whether or not the power source is set not to be supplied from the cable 8 at step S13, control branches to YES and proceeds to step S16.

Meanwhile, the power source supervisory circuit 3 detects if a voltage value (for example, 5V) capable of being used at the telephone device 1 is not reached through the interface cable 8 to the connector 1a to the power source supplying path V1 while the power source supervisory circuit 4 detects if a voltage value (for example, 5V) capable of being used at the telephone device 1 is not reached through the charger 10 to the connector 1b to the power source supplying path V2. Then, information on the power source voltage is transmitted to the power source switch circuit 5 through the control line C1 and the control line C2 as well.

Based on information on the power source voltage, the power source switch circuit 5, as shown at step S16 in FIG. 5, exceptionally switches over to the side of the power source supplying path V4 from the secondary battery 7 to thereby apply the power source voltage to the telephone circuit 2 through the power source switch circuit 5. Further, the power source switch circuit 5 can perform exceptional switching as set from the telephone circuit 2.

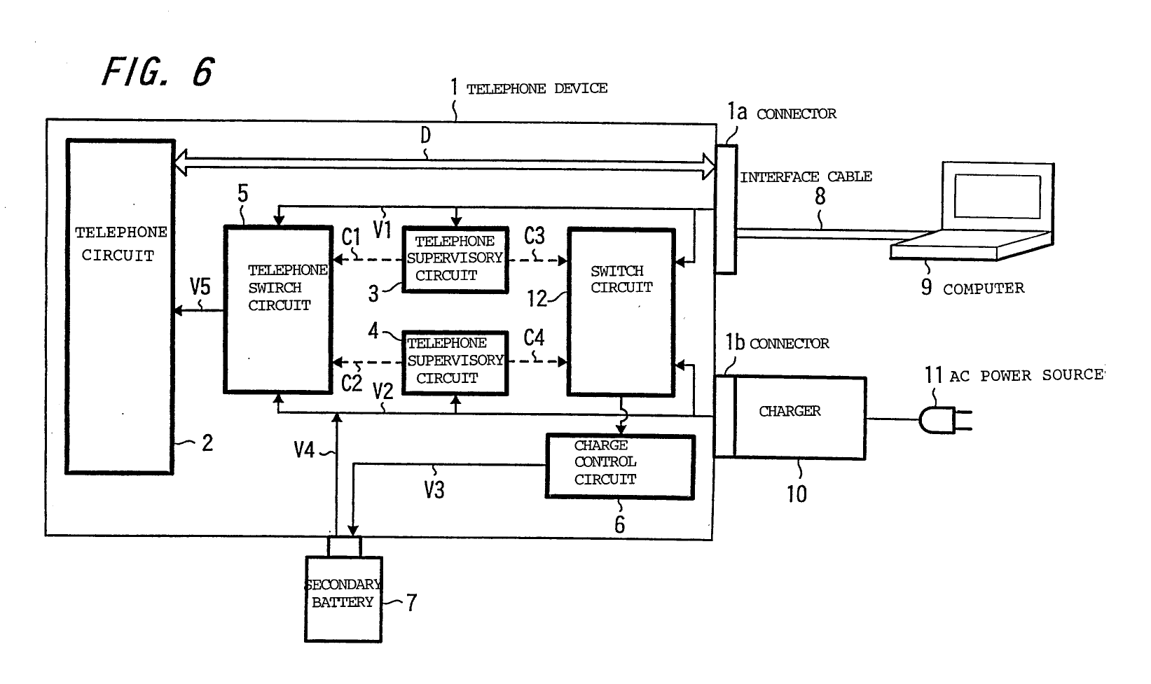

FIG. 6 is a block diagram to show switching of power source supplying paths and charge paths.

FIG. 6 shows a configuration of when the power source voltage is applied to the telephone circuit 2 from the computer 9 through interface cable 8 or when the power source voltage is applied to the telephone circuit 2 from the charger 10 with the secondary battery 7 being charged simultaneously.

FIG. 6 differs from FIG. 1 in that the former is configured such that the computer 9 is connected to the connector 1a through the interface cable 8, data D is transmitted and received between the computer 9 and the telephone circuit 2, the computer 9 can apply the power source voltage to the telephone circuit 2 through the interface cable 8 having the power source supplying line, and further, in case the charger 10 capable of generating a suppliable predetermined DC (direct current) power source (for example, 5V) from a commercial AC (alternating current) power source 11 is connected to the connector 1b so that the power voltage, between the charger 10 and the telephone circuit 2, can be applied to the telephone circuit 2 through the connector 1b, and further, based on information about the power source voltage from the power source supervisory circuit 3 and the power source supervisory circuit 4, a switch circuit 12 switches the power source supplying paths through a charge control circuit 6, which charge the secondary battery.

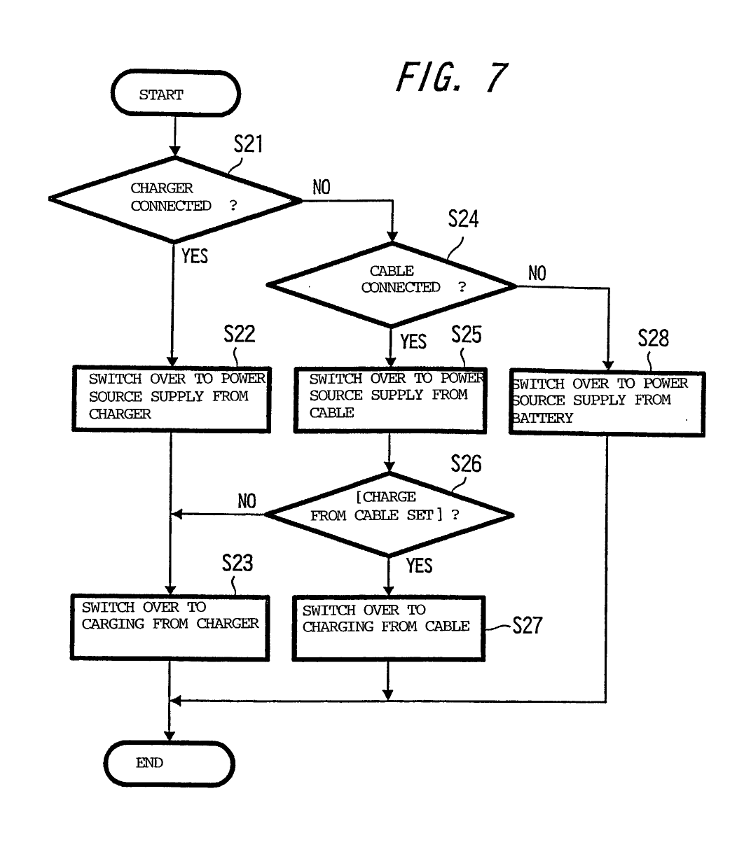

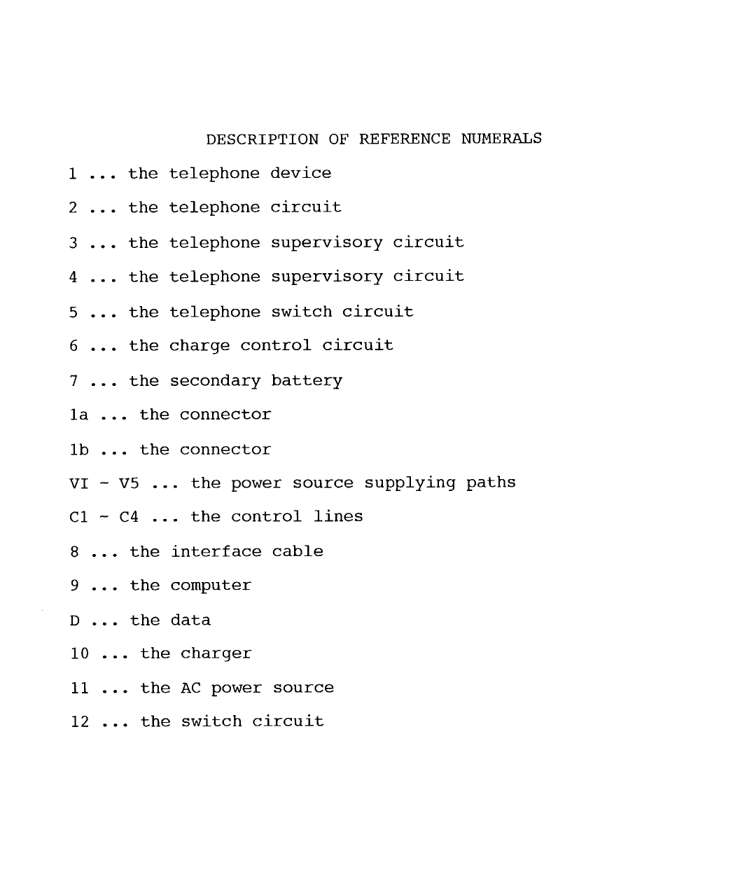

The telephone device 1 thus configured performs the following operations. Incidentally, FIG. 7 is a flowchart showing switch operations of the power source supplying paths and the charge path.

Further, judgement at steps S21, S24 to processing at step S28 shown in FIG. 7 shows switch operations of the power source supplying paths in FIG. 1 similarly to judgement at steps S1, S3 to processing at step S5 shown in FIG. 4.

Furthermore, judgement at steps S21, S24 to processing at step S25 shown in FIG. 7 shows switch operations of the power source supplying paths in FIG. 2 similarly to judgement at steps S1, S3 to processing at step S4 shown in FIG. 4 do.

Furthermore, judgement at steps S21 to processing at step S22 shown in FIG. 7 shows switch operations of the power source supplying paths in FIG. 3 similarly to judgement at step S1 to processing at step S2 shown in FIG. 4.

Additionally, after the switch operation of the power source supplying paths by processing at step S28 in FIG. 1, control exits from processing.

Here, after the switch operation of the power source supplying paths by processing at step S25 in FIG. 2, control proceeds to step S26 and judges whether or not [charge from the cable] is set at step S26 and when charge from the interface cable 8 is possible, control branches to YES and proceeds to step S27.

Meanwhile, the power source supervisory circuit 3 detects that a voltage value (for example, 5V) is reached, which is capable of being used for charging the secondary battery 7 through the interface cable and the connector 1b to the power source supplying path V1 to the charge control circuit 6 and the power source supplying path V3, and information on the power source voltage is transmitted to a switch circuit 5 through a control line C3. The power source supervisory circuit 3 performs judgement at step S26 by detecting the voltage value capable of being used for charging the secondary battery 7.

Further, the power source supervisory circuit 4 detects that a voltage value is not reached, which is capable of being used for charging the secondary battery 7 through the charger 10 and the connector 1b to the power source supplying path V2 and information on the power source voltage is transmitted to a switch circuit 12 through a control line C4. Incidentally, the switch circuit 12 can perform switching as set from the telephone circuit 2.

Based on information on the power source voltage the switch circuit 12, as shown at step S27 in FIG. 7, performs switching so that the side of the power source supplying path V1 from the interface cable 8 becomes electrically conducitive to the side of the charging control circuit 6 and the power source supplying path V3 as well to thereby apply the power source voltage for charging the secondary battery 7.

Consequently, whilst the power source supplying paths are subjected to switch operations in FIG. 2, charging of the secondary battery 7 can be performed by the power source voltage supplied from the interface cable 8.

In addition, when the charging from the interface cable 8 can not be performed at step S26, control branches to NO and proceeds to step S23.

For example, when the interface cable is disconnected from the connector 1a so that the power source voltage can not be applied to the telephone device 1, or when an abundant supply of the power source voltage can not be secured as the computer 9 is being driven by an internally stored battery, or when an abundant supply of the power source voltage can not be secured because the power source supplying ability on the side of the computer 9 deteriorates due to the exhaustion of an internally stored battery even though the charger is being used, the power source supervisory circuit 3 transmits information on the power source voltage to the switch circuit 12 through the control line C3.

In addition, after the switch operations in FIG. 3 of the power source supplying paths by processing at step S22, control proceeds to step S23.

The power source supervisory circuit 4 detects that a voltage value (for example. 5V) is reached, which is capable of being used for charging the secondary battery 7 through the charger 10 and the connector 1b to the power source supplying path V2 and information on the power source voltage is transmitted to the switch circuit 12 through a control line C4.

Based on this information on the power source voltage, the switch circuit 12, as shown at step S23 in FIG. 7, performs switching so that the side of the power source supplying path V2 from the charger 10 becomes electrically conductive to the side of the charge control circuit 6 and the power source supplying path V3 to thereby apply the power source voltage for charging the secondary battery 7 through the charge control circuit 6 and the power source supplying path V3.

Consequently, while the power source supplying paths are subjected to switch operations in FIG. 3, it becomes possible to charge the secondary battery 7 with the power source voltage supplied from the charger 10.

[Serial Bus in USB Format]

Explanations will be given to only a portion relating to power source supplying by serial bus in USB format (hereinafter, referred to as USB) as applied to an interface according to the embodiments of the present invention.

First of all, a host controller (master) will be explained. In USB a chip called host controller commands everything. Any transfer is started by the host controller and peripheral equipment (slave) sends a reply if there exists data that can be sent back. If there is none, the slave returns a reply saying that there is no data to send back, or notifies that sent-in data will be received for processing or won't be received. That is, although peripheral equipment is ready for data transfer, it can not positively make a transfer demand only to keep on waiting for the order of the host controller to arrive.

Next, a connections pattern will be explained. Connections in UBS is realized by a configuration called hierarchical startopology. In this topology a host controller inside of a personal computer plays a starting point with peripheral equipment connected thereto.

Next, a cable will be explained. A UBS cable comprises 4 signal lines, two of them being for data transfer and the remaining two being for power sources. A data line uses a twist pair line and USB 1.1 transfers a differential signal of an amplitude of 3.3V, while a power source line comprises a 5V power source and GND (ground).

Next, a connector will be explained. The USB connector has two kinds of shapes, namely, series A and series B. They are so prescribed lest that both of downstream ports or upstream ports are connected to each other by mistake. A-type connector is prepared for a downstream port from a personal computer and B-type connector is prepared for connecting to the ports of peripheral equipment.

Next, power control will be explained. There are prescribed a self-power device and a bus-powered device for USB. The USB devices can be categorized into, for example, a self-powered device having its own power source such as personal computer, telephone device, print device and the like according to the embodiments of the present invention and bus-powered devices that are in need of receiving power from a bus line such as telephone device, keyboard, mouse and the like according to the embodiments of the present invention. The maximum value of power current the bus-powered device can receive is 500 mA. Equipment in need of power supplying of 500 mA and more at 5V is not permitted as a bus-powered device for USB.

Since the bus-powered device does not have its own power source, it distributes upstream busline power and in the case of 4 down stream ports, supplies at the maximum 100 mA current to each of the downstream ports. Accordingly, the bus-powered device in need of up to 500 mA at 5V of power are not allowed to make cascade-connections to the downstream port of the bus-powered device.

In addition, when it comes to USB 2.0, power to be supplied to each of the downstream ports can variably be set in the case of 4 downstream ports.

Power to be supplied to, for example, a personal computer (master) and print device (master, slave), a camera device (slave), a telephone device (slave), DSU (digital service unit) (slave), and a monitor device (slave) can variably be set.

[Serial Bus in IEEE1394 Format]

Explanations will be given to only a portion relating to power supplying by serial bus in IEEE1394 format (hereinafter, referred to as 1394 serial bus) as applied to an interface according to the embodiments of the present invention.

First of all, connections pattern will be explained. Although a connections pattern is limited in serial bus, 63 units of equipment can be connected to one bus at the maximum by connecting together each equipment in a loopless tree-shape fashion. Each port of the equipment transmits a received data signal continuously to another port so that the data signal spreads to all of the bus.

Next, a cable will be explained. The cable comprises two sets of differential signal line TPA and TPB, power source pair VG (ground) and VP (power source). Two strings of a signal line TPA and TPB perform dynamic configuration of the bus, arbitration for obtaining the right to use the bus, and propagation of the data signal. TPA is always biased, which TPB detects to thereby determine whether or not active cable connections are in place.

In this 6 pin cable, the power source pair VG (ground) and the VP (power source) can supply maximum power of 60 W (40V, 1.5 A).

In addition, the above-mentioned embodiment showed a case in which the computer 9 is connected to the telephone device 1 through the interface cable 8. However, it is not limited to the case. The embodiment may be applied to information terminal devices replacing the computer 9, as comprise electronic equipment such as a telephone device capable of being connected with an interface cable having a power source supplying line, a print device, a camera device, a television receiver, a facsimile device and the like.

POSSIBILITY FOR INDUSTRIAL USE

The present invention can be used for information terminal devices capable of transmitting and receiving information such as, for example, a telephone device, a print device, a camera device and the like.

1. In an information terminal device for transmitting and receiving information through a communication means,
an information terminal device being characterized by comprising;
an internally stored power source unit for applying a power source voltage to said communication means,
a charging means for charging a voltage stored at said internally stored power source unit, and
a connection unit capable of being connected with an interface cable having a power source supplying line for applying the power source voltage to said communication means.

2. In an information terminal device according to claim 1,
an information terminal device being characterized by comprising a first power source voltage applying means from the said internally stored power source unit, a second power source voltage applying means from said charging means, a third power source voltage applying means supplied to said connection unit from outside through a power source supplying line of said interface cable, and a power receiving means for receiving the power source voltage from any one of said first to third power source voltage applying means.

3. In an information terminal device according to claim 2,
an information terminal device being characterized by comprising a first supervisory means for supervising the voltage applied from the first power source voltage applying means of said internally stored power source unit and the voltage applied from the third power source voltage applying means supplied to said connection unit from outside through the power source supplying line of said interface cable, and based on the results of the supervision by said first supervisory means, by providing a switch means for switching the power source voltage at said power receiving means to either of said first or third power source voltage applying means

4. In an information terminal device according to claim 2,
an information terminal device being characterized by comprising a second supervisory means for supervising the voltage from said power charging means as applied from the second power source voltage applying means and the voltage applied from the third power source voltage applying means supplied to said connection unit from outside through the power source supplying line of said interface cable, and based on the results of the supervision by said second supervisory means, by providing a switch means for switching the power source voltage received at said power receiving means to either of said second or third power source applying means.

5. In an information terminal device according to claim 2,
an information terminal device being characterized by comprising a switch means for preferentially switching the power source voltage received at said power receiving means successively over to the second power source voltage applying means from said power charging means, the third power source voltage applying means supplied to said connection means from outside through the power source line of said interface cable and the first power source voltage applying means from said internally stored power source unit.

6. In an information terminal device according to claim 5,
an information terminal device being characterized by replacing the order of said third power source voltage applying means and said first power source voltage applying means in case the power source supplying line of said interface cable is predetermined.

7. In an information terminal device according to claim 2,
an information terminal device being characterized by applying the power source voltage for charging a voltage stored at said internally stored power source unit from either of the second power source voltage applying means from said charging means and the third power source voltage applying means supplied to said connection unit from outside through the power source supplying line of said interface cable.
